(19) United States
(12) Patent Application Publication
(10) Pub. No.: US 2024/0420520 A1
(43) Pub. Date: Dec. 19, 2024

(54) Systems and Methods for Volumetric Efficiency Diagnostic of an Engine

(71) Applicant: Robert Bosch GmbH, Stuttgart (DE)

(72) Inventor: Charles Lee Murphy, Forsythe, GA (US)

(21) Appl. No.: 18/211,415

(22) Filed: Jun. 19, 2023

(51) Int. Cl. G07C 5/08; G07C 5/00

(52) U.S. Cl. CPC G07C 5/0808; G07C 5/008; G07C 5/0825; G07C 5/085

(57) ABSTRACT

A method and system for diagnostic service of a vehicle with an internal combustion engine based upon a volumetric efficiency calculation of the engine. The volumetric efficiency calculation is based upon mass airflow data from a mass airflow sensor. Volumetric efficiency values below a threshold value may be related to a number of operating conditions of the engine. A guided service operation may include instructions for a user to perform service operations to improve operating conditions of the vehicle.

### TECHNICAL FIELD

This disclosure relates to vehicle diagnostics. In particular, the disclosure relates to diagnostics pertaining to the airflow and volumetric efficiency of internal combustion engines.

### BACKGROUND

Volumetric efficiency is a measure of how much air is passing through an internal combustion engine compared to what the theoretical maximum amount of air that can be passed through during each revolution. A theoretical maximum efficiency of 100% is not possible, but very high efficiencies can be observed in a properly maintained engine running at high loads. Under lower loads, the air intake is reduced, and the expected volumetric efficiency is similarly reduced.

A rapid indication of volumetric efficiency is useful in quickly diagnosing potential issues with the operation of an engine. Contemporary tools to measure volumetric efficiency work on intermittent measurements and provide the measurements to a user without additional context. What is desired is a tool that provides rapid measurements of volumetric efficiency and additional context to provide a user with information suitable to quickly perform service or repairs on an engine.

### SUMMARY

One aspect of this disclosure is directed to a diagnostic method for an internal combustion engine, the method comprises establishing a data connection between a diagnostic processor and a vehicle communication bus (VCB) of a vehicle utilizing the engine, requesting mass airflow data from the VCB, displaying the mass airflow data on a display in data communication with the diagnostic processor in response to reception of the mass airflow data from the VCB, generating an efficiency indicator of a volumetric efficiency of the engine based upon the mass airflow data, generating a diagnosis indicator based upon the volumetric efficiency, generating a diagnosis indicator based upon the volumetric efficiency, and displaying the efficiency indicator and the diagnosis indicator on the display. The mass airflow data indicates mass airflow of combined cylinders of the engine during operation of the engine. The method comprises additional steps wherein the VCB acquires the mass airflow data from a sensor in data communication with the VCB, the diagnosis indicator indicates normal operation of the engine in response to the volumetric efficiency being equal to or greater than a threshold value, and the diagnosis indicator indicates an engine fault in response to the volumetric efficiency being below the threshold value. The threshold value is established using identifying data associated with the vehicle, which may be acquired from the VCB in an autonomous manner. In some embodiments, the data communication between the memory and the diagnostic processor utilizes a network connection. In some embodiments, the sensor is disposed within the engine airflow pathway between the air filter and the intake manifold.

Another aspect of this disclosure is directed to a diagnostic system comprising a mass airflow sensor, a diagnostic bus in data communication with the mass airflow sensor, a diagnostic processor in data communication with the diagnostic bus, and a display in data communication with the diagnostic processor. The mass airflow sensor generates mass airflow data indicating mass airflow conditions of the engine. In some embodiments, the mass airflow sensor is disposed in the airflow pathway of an engine between an air filter and intake manifold of the engine. The diagnostic processor is configured to transmit commands to the diagnostic bus and receive data from the diagnostic bus. The diagnostic processor is configured to transmit diagnosis data for output via the display, wherein the diagnostic bus acquires the mass airflow data from the mass airflow sensor, the diagnostic bus transmits the mass airflow data to the diagnostic processor, the diagnostic processor generates a volumetric efficiency of the engine based upon the mass airflow data, the diagnosis data indicates normal operation of the engine in response to the volumetric efficiency being equal to or greater than a threshold value, and the diagnosis data indicates an engine fault in response to the volumetric efficiency being below the threshold value. Some embodiments comprise a memory in data communication with the diagnostic processor, the memory having stored thereon an expected mass airflow value that is used to generate the threshold value. In some embodiments, the diagnostic processor is configured to generate additional service instructions in response to the volumetric efficiency being below the threshold value. The additional service instructions may be transmitted to a display or other output for a user to utilize in servicing the engine or other components of a vehicle associated with the engine.

The above aspects of this disclosure and other aspects will be explained in greater detail below with reference to the attached drawings.

### BRIEF DESCRIPTION OF THE DRAWINGS

FIG. 1 is a diagrammatic illustration of a diagnostic system.

FIG. 2 is a diagrammatic illustration of an engine airflow pathway.

FIG. 3 is a flowchart illustrating a method of diagnostic service for a vehicle.

FIG. 4 is a flowchart illustrating a method of diagnostic service for a vehicle.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

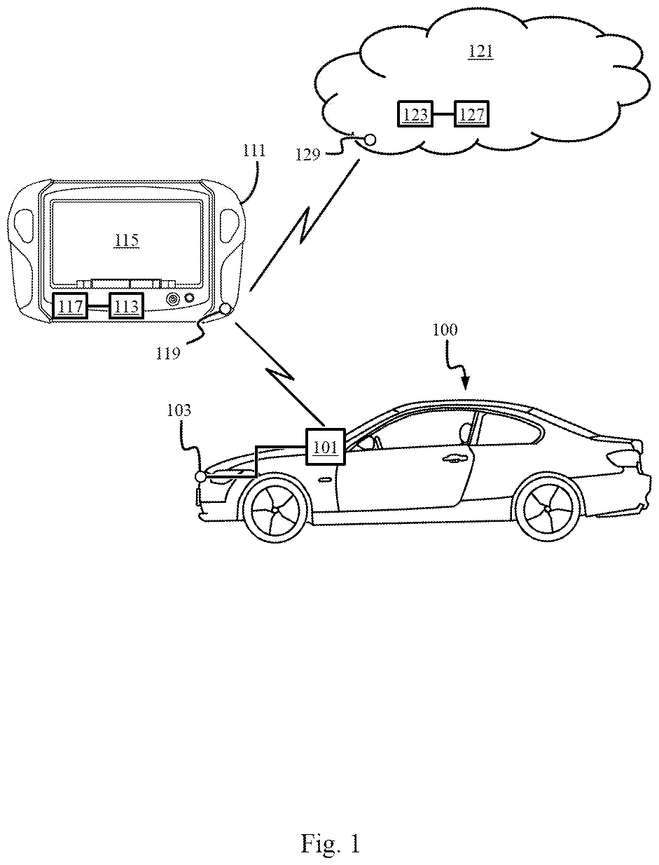

FIG. 1 is a diagrammatic illustration of a diagnostic system according to one embodiment of the teachings disclosed herein. The depicted diagnostic system is directed to a vehicle 100 having an internal combustion engine (not shown) and a vehicle communication bus (VCB) 101. In the depicted embodiment, vehicle 100 comprises a consumer sedan, but other embodiments may utilize a compact car, microcar, sports car, minivan, crossover, sport utility vehicle, utility van, light truck, industrial truck, motorcycle, side-by-side recreational vehicle, on-road recreational vehicle, off-road recreational vehicle, or any other vehicle utilizing an engine having an airflow pathway without deviating from the teachings disclosed herein.

In the depicted embodiment, VCB 101 may comprise a controller area network (CAN) bus, but other embodiments may comprise other configurations of VCB 101 utilizing different diagnostic protocols without deviating from the teachings disclosed herein. VCB 101 comprises a diagnostic bus suitable to transmit messages between components of vehicle 100 and external diagnostic tools. The messages transmitted between the components and an external diagnostic tool may comprise diagnostic trouble codes (DTCs), or any other diagnostic data useful for an external tool to diagnostic and service components of vehicle 100. A sensor 103 is in data communication with VCB 101 and generates sensor data indicating an operating condition of the vehicle. In the depicted embodiment, sensor 103 comprises a mass airflow sensor 103, but other embodiments may comprise other configurations without deviating from the teachings disclosed herein. In the depicted embodiment, mass airflow sensor 103 may be a standard feature of vehicle 100, an aftermarket inclusion to vehicle 100, or a temporary inclusion provided by a technician during diagnostic service of vehicle 100 without deviating from the teachings disclosed herein.

In the depicted embodiment, VCB 101 is in data communication with an external diagnostic tool in the form of a scan tool 111. Scan tool 111 comprises a human-machine interface (HMI) 115 permitting a user to input commands or data and receive information or data from scan tool 111. In the depicted embodiment, HMI 115 comprises a touchscreen display and a plurality of soft keys and hardware buttons, but other embodiments may comprise other forms of input or output without deviating from the teachings disclosed herein.

Although the external diagnostic device is embodied in the depicted embodiment as scan tool 111, in other embodiments it may be embodied as a mobile processing device, a smartphone, a tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art.

Scan tool 111 additionally comprises a diagnostic processor 113 and a diagnostic memory 117. Diagnostic processor is suitable to generate commands and transfer other data between scan tool 111 and VCB 101. In the depicted embodiment, diagnostic processor 113 is in data communication with VCB 101 via a wireless data connection, but other embodiments may comprise different or additional communication protocols without deviating from the teachings disclosed herein.

Wireless data communication may be accomplished via a transceiver circuit 119 of Scan tool 111 in data communication with VCB 101. In the depicted embodiment, transceiver circuit 119 is suitable to exchange digital communications with an external device (such as VCB 101). In the depicted embodiment, transceiver circuit 119 comprises a transmitter and receiver component, but other embodiments may comprise other configurations having a separate transmitter and receiver without deviating from the teachings disclosed herein. Transceiver circuit 119 is in data communication with diagnostic processor 113 Diagnostic processor 113 and VCB 101 may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art.

In some embodiments, transceiver circuit 119 may instead or additionally comprise configurations suitable for wired data connectivity. In such embodiments, transceiver circuit 119 may comprise an onboard diagnostic (OBD) protocol connection, TCP/IP connection, a local area network (LAN) connection, a plain-old-telephone-service (POTS) connection, an Internet protocol connection, an electrical wiring, a conductive channel, an electrical bus, a fiber optic pathway, or any other alternative embodiment known to one of ordinary skill in the art.

Diagnostic processor 113 may provide a user with information stored within diagnostic memory 113 pertaining to service based upon data received from VCB 101. Diagnostic processor 113 may additionally retrieve data from an additional external source, such as a remote server 121 comprised of a remote processor 123 and a remote memory 127. The remote server 121 additionally comprises a remote transceiver 129 which is in data communication with scan tool 111. In the depicted embodiment, the data communication between scan tool 111 and remote server 121 is accomplished via a wireless Internet connection, but other embodiments may comprise other configurations utilized a local area network, direct connection, wired Internet connection, or any other data communication connectivity protocol recognized by one of ordinary skill in the art without deviating from the teachings disclosed herein.

In the depicted embodiment, one or both of diagnostic processor 113 and remote processor 123 may collect data received from VCB 101 and store the data in one or both of the associated diagnostic memory 117 or remote memory 121. The collected data may be organized into a corpus of diagnostic history data and subsequently utilized by diagnostic processor 113 or remote processor 123 for the purposes of machine-learning of diagnostic results. In the depicted embodiment, remote processor 123 limits access to the corpus of diagnostic history data, and a user of diagnostic processor 113 may access the corpus in exchange for a payment. The payment may be in the form of an ad hoc payment, a subscription payment, a temporary access fee, or some combination thereof. In some embodiments, combinations of payments may be offered to users, with different tiers of payment being offered to provide access to different parts of the corpus, which may be organized by diagnostic severity, component type, or another organizational method recognized by one of ordinary skill in the art at the time the invention was made.

In the depicted embodiment, diagnostic processor 113 may be particularly directed to analysis of data generated by mass airflow sensor 103, which can be utilized to quickly eliminate a number of diagnoses based upon volumetric analysis of the mass airflow data generated. By way of example, and not limitation, a modern well-tuned engine may be expected to exhibit a volumetric efficiency of 80-90% during heavy load operation. Diagnostic processor 113 may receive mass airflow data from mass airflow sensor 103 and additionally tacheometry data from other sensors in data communication with VCB 101 and compare these values to a corpus of expected values. In the depicted embodiment, this corpus may comprise a table of expected values under controlled conditions for a particular make and model of vehicle 100. The corpus may include a plurality of such tables of values comparing engine load and volumetric efficiency values, each of the plurality of tables corresponding to a different make and model of a vehicle. The volumetric efficiency data may be provided by VCB 101, or raw sensor data indicating total mass airflow may be transmitted to diagnostic processor 103 and the volumetric efficiency may be calculated by diagnostic processor 103 based upon the raw data and the known total air volume for a particular make and model of vehicle 100.

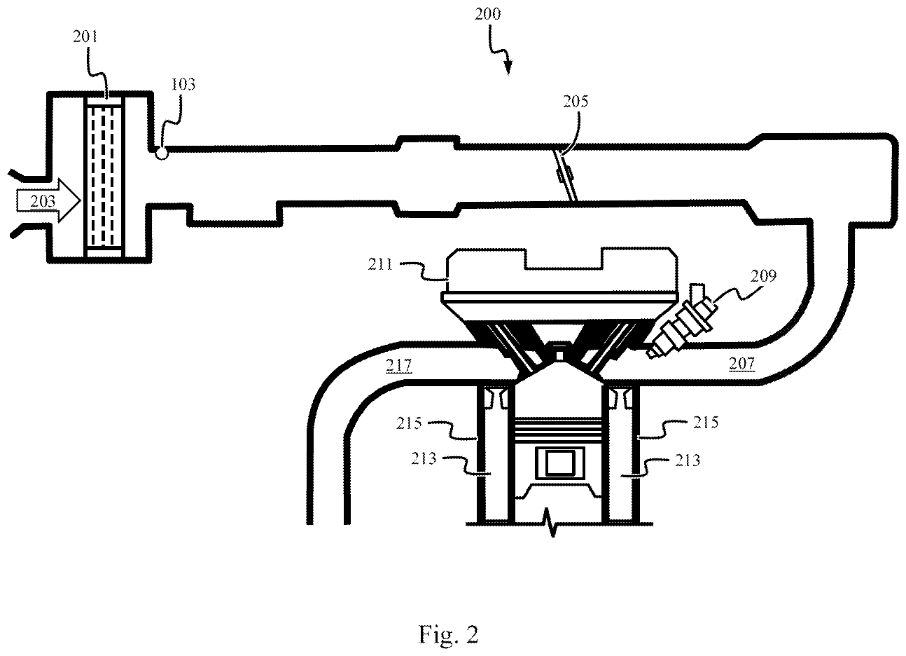

FIG. 2 is a diagrammatic illustration of the airflow circuit 200 of an engine of a vehicle (such as vehicle 100; see FIG. 1). Air intake is accomplished by pulling air through an air filter 201 in a direction 203. The air flow continues through the airflow circuit 200 past a throttle valve 205 into an intake manifold 207. At intake manifold 207, the air is mixed with fuel by a fuel injector 209, before the air-fuel mixture enters engine 211. Engine 211 comprises a number of pistons 213 disposed within a number of cylinders 215. Engine 211 utilizes the airflow and air-fuel mixture to generate movement within pistons 213 that is used for locomotion of the associated vehicle. During a four-stroke cycle, air additionally flows out of engine 211 via an exhaust conduit 217. The total mass airflow through the airflow circuit 200 can be measured by a mass airflow sensor 103 (see also FIG. 1). In the depicted embodiment, mass airflow sensor 103 is disposed within the airflow circuit 200 path immediately after air filter 201, but in other embodiments mass airflow sensor 103 may be disposed elsewhere within the airflow circuit 200 without deviating from the teachings disclosed herein. Some embodiments may comprise additional mass airflow sensors 103 without deviating from the teachings disclosed herein.

If the volumetric efficiency data calculated during a diagnostic test utilizing mass airflow data from mass airflow sensor 103 is within an expected operating range for the particular make and model of vehicle 100 (see FIG. 1), the diagnostic processor 101 (see FIG. 1) can update HMI 115 (see FIG. 1) to indicate to the user that none of a plurality of potential conditions are indicated by operation of the vehicle 100. By way of example, and not limitation, a modern engine operating at relatively high tacheometry loads may be expected to exhibit an 80-90% volumetric efficiency. Other vehicles may exhibit different volumetric efficiencies of different values, particularly if the engine is of an older model (wherein a lower volumetric efficiency is expected) or if the engine comprises a turbo-charger or super-charger component (which can operate to force a higher volumetric efficiency even beyond the nominal 100% efficiency of the same engine without such a component).

If the volumetric efficiency calculated is below the expected conditions, this measurement may correspond to one or more of a number of known operational conditions of vehicle 100 that warrant servicing. By way of example, and not limitation, the conditions that result in a lowered volumetric efficiency may comprise a fault or suboptimal operation of the mass airflow sensor 103, the air filter 201, the exhaust conduit 217, one or more of cylinders 215, or the pathway of airflow circuit 200. Service operations for each of these components may be presented to the user to be performed in an attempt to rectify the lowered volumetric efficiency. During service, diagnostic processor 113 can continue to request mass airflow data from mass airflow sensor 103 and calculate updated values for volumetric efficiency. As each service operation is completed by a user, the HMI 115 may be updated to continually show a user the current volumetric efficiency. By way of example, and not limitation, the diagnostic processor 113 may request mass airflow data up to 5 times per second, but other embodiments may utilize a different frequency of data request without deviating from the teachings disclosed herein. Thus, a user can have a near real-time analysis of the volumetric efficiency of engine 211, including any changes that result from each service operation. By way of example, and not limitation, the service operations may comprise a sensor verification of mass airflow sensor 103, a visual inspection and/or replacement of air filter 201, an air pressure measurement of the interior of exhaust conduit 217, an audio analysis of the sounds made during operation of engine 211, or a compression check to measure the mechanical integrity of the airflow circuit 200. Additional or different service operations may be presented to a user without deviating from the teachings disclosed herein. In the depicted embodiment, the service operations may be presented to a user in a particular order, but other embodiments may utilize a different order of suggested service operations without deviating from the teachings disclosed herein.

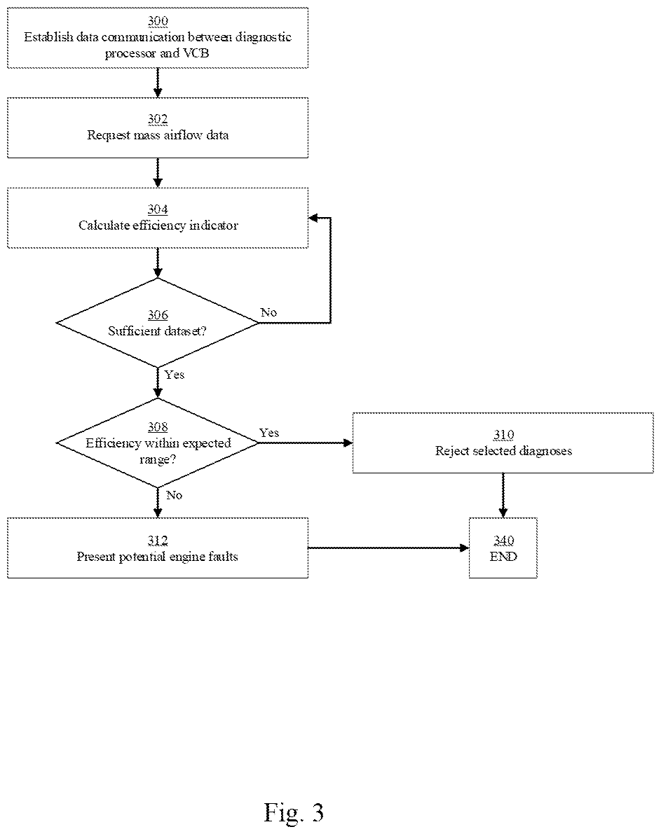

FIG. 3 is a flowchart illustrating a method of utilizing volumetric efficiency data to make diagnostic assessments of an engine (such as engine 211; see FIG. 2) of a vehicle (such as vehicle 100; see FIG. 1). The method beings at step 300 where data communication is established between a vehicle communication bus (“VCB,” such as VCB 101; see FIG. 1) and a diagnostic processor (such as diagnostic processor 113; see FIG. 1). In the depicted embodiment, establishing data communication may additionally comprise exchanging identifying data from the VCB to the diagnostic processor. The identifying data may comprise information identifying the make and model of the vehicle, make and model of the engine, or other identifying data for other components in communication with the VCB. After the data communication is established, the method proceeds to step 302, where mass airflow data is requested by the diagnostic processor and transmitted by the VCB. In the depicted embodiment, additional data may be requested of the VCB, such as tachometer data indicating a tacheometric load of the engine associated with the vehicle (such as engine 211; see FIG. 2). After this mass airflow data is acquired, the volumetric efficiency is calculated at step 304, and an indicator is generated for presentation to a user via a human-machine interface (“HMI,” such as HMI 115; see FIG. 1). In the depicted embodiment, a number of cycles of data requests are utilized to stabilize the volumetric efficiency value, and the method proceeds to step 306 to determine if there have been a sufficient number of data exchanges to reliably calculate a stable volumetric efficiency value. In the depicted embodiment, the volumetric efficiency measurements may yield both a weighted average value for volumetric efficiency and a peak volumetric efficiency value. By way of example, and not limitation, the weighted average volumetric efficiency measurement may be a weighted arithmetic average of a finite number of the most recent instant volumetric efficiency calculations. By way of example, and not limitation, the peak volumetric efficiency value may be a maximum calculated value of an instant volumetric efficiency calculations from within a predetermined window of operating time during operation of the engine (such as the most recent 5 minutes of operation). Other embodiments may comprise different volumetric efficiency measurements without deviating from the teachings disclosed herein.

Once a specified dataset has been acquired and suitable volumetric efficiency data has been calculated, this data may be presented to a user via the HMI, and the method proceeds to step 308, where the volumetric efficiency data is compared to au expected range for the vehicle's make, model, and tachometric load during operation. In the depicted embodiment, the expected range may be specified by one or more threshold values indicating a minimum efficiency of expected operation for vehicle having the same make, model, and age of the vehicle under test. If the volumetric efficiency is greater than the threshold values, the engine is operating with expected volumetric efficiency and the method can proceed to step 310, where all correlated possible diagnoses can be rejected from service requirements. Advantageously, utilization of volumetric efficiency calculations can quickly discount a number of possible diagnostic steps to determine what service is needed for the engine. However, if the volumetric efficiency data is outside the expected range, the method can instead proceed to step 312, where a list of related diagnostic and service operations may be presented to a user for completion to return the vehicle to expected operational condition.

The method depicted in FIG. 3 presents one embodiment of a diagnostic method according to the invention disclosed herein. Other embodiments may comprise additional or different steps without deviating from the teachings disclosed herein.

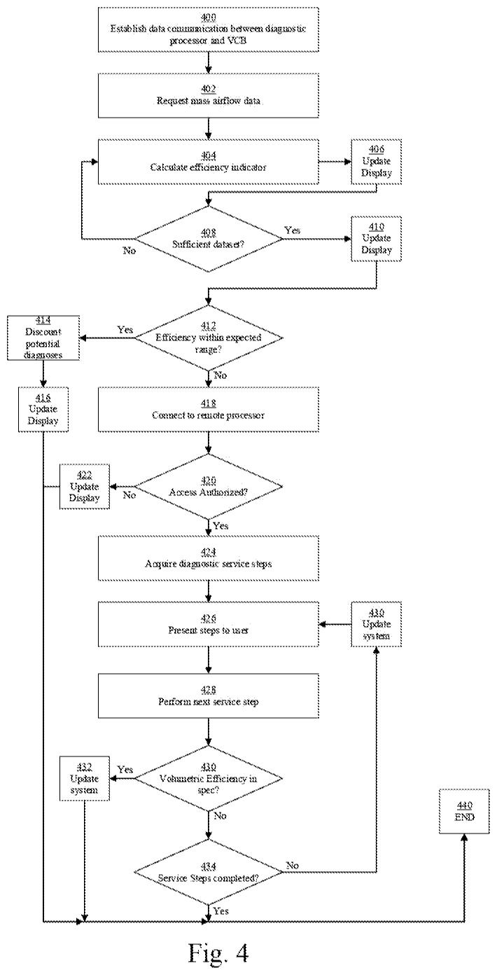

FIG. 4 is a flowchart for an alternative embodiment of volumetric efficiency diagnostic according to the teachings disclosed herein.

The method beings at step 400 where data communication is established between a vehicle communication bus (“VCB,” such as VCB 101; see FIG. 1) and a diagnostic processor (such as diagnostic processor 113; see FIG. 1). In the depicted embodiment, establishing data communication may additionally comprise exchanging identifying data from the VCB to the diagnostic processor. The identifying data may comprise information identifying the make and model of the vehicle, make and model of the engine, or other identifying data for other components in communication with the VCB. After the data communication is established, the method proceeds to step 402, where mass airflow data is requested by the diagnostic processor and transmitted by the VCB. In the depicted embodiment, additional data may be requested of the VCB, such as tachometer data indicating a tacheometric load of the engine associated with the vehicle (such as engine 211; see FIG. 2). After this mass airflow data is acquired, the volumetric efficiency is calculated at step 404, and an indicator is generated for presentation to a user via a human-machine interface (“HMI,” such as HMI 115; see FIG. 1). In the depicted embodiment, the HMI of the method comprises at least a display, but other embodiments may comprise different or additional features known to one of ordinary skill without deviating from the teachings disclosed herein.

The generated indicator is presented to a user via the HMI at step 406, to provide a near real-time updated value for a user. In the depicted embodiment, a number of cycles of data requests are utilized to stabilize the volumetric efficiency value, and the method proceeds to step 408 to determine if there have been a sufficient number of data exchanges to reliably calculate a stable volumetric efficiency value. If not, the method returns to step 404 to request additional data. In the depicted embodiment, the volumetric efficiency measurements may yield both a weighted average value for volumetric efficiency and a peak volumetric efficiency value. By way of example, and not limitation, the weighted average volumetric efficiency measurement may be a weighted arithmetic average of a finite number of the most recent instant volumetric efficiency calculations. By way of example, and not limitation, the peak volumetric efficiency value may be a maximum calculated value of an instant volumetric efficiency calculations from within a predetermined window of operating time during service (such as the most recent 5 minutes of operation). Other embodiments may comprise different volumetric efficiency measurements without deviating from the teachings disclosed herein.

Once a specified dataset has been acquired and suitable volumetric efficiency data has been calculated, this data may be presented to a user via the HMI at step 410, and the method proceeds to step 412, where the volumetric efficiency data is compared to an expected range for the vehicle's make, model, and tachometric load during operation. In the depicted embodiment, the expected range may be specified by one or more threshold values indicating a minimum efficiency of expected operation for vehicle having the same make, model, and age of the vehicle under test. If the volumetric efficiency is greater than the threshold values, the engine is operating with expected volumetric efficiency and the method can proceed to step 414, where all correlated possible diagnoses can be discounted from service requirements, and the HMI is updated at step 416 with a final volumetric efficiency reading before the method completes. Advantageously, utilization of volumetric efficiency calculations can quickly discount a number of possible diagnostic steps to determine what service is needed for the engine.

However, if the volumetric efficiency data is outside the expected range, the method can instead proceed to step 418, where the user or diagnostic processor can establish data communication to a remote server (such as remote server 121; see FIG. 1) housing additional diagnostic and service information in a memory (such as remote memory 127; see FIG. 1).

After data communication is established, the method proceeds to check whether the user is authorized to access data from the remote server at step 420. Access to the remote server may be controlled based upon a status associated with a user or diagnostic processor stored in the memory of the server. In the depicted embodiment, the access to the information of the remote server is controlled via a paywall, an a user may gain authorization via a payment to the operator of the remote server. Payment may comprise a subscription-based model authorizing access to all or parts of the information stored on the remote server so long as a subscription payment is kept up-to-date. Payment may comprise an ad hoc model, where a user provides payment for access to specific parts of the information stored by the remote server. In the ad hoc model, access may be granted permanently or for a limited duration of time in response to receipt of an ad hoc payment. Payment may comprise an a la carte access to different parts of the information stored by the remote server, where a user pays once in advance and retains permanent access to corresponding selected parts of the information stored upon the remote server. Access may also be organized into different customer tiers, where users who pay at different rates are authorized for different amounts of information. In some embodiments, other services may be enabled based upon authorization level. By way of example, and not limitation, the remote server may provide a user who has sufficient authorization additional service instructions to guide a user through a service operation to address a diagnosis based upon data received from the VCB. These instructions may be transmitted to the diagnostic processor and presented via the HMI, but other embodiments may comprise other arrangements without deviating from the teachings disclosed herein.

In some embodiments, the remote server's memory storage may comprise a corpus of diagnostic history data, and this corpus may be utilized by a machine-learning method executed by the diagnostic processor to selectively present service operations to a user that may be applicable to the instant diagnosis of a vehicle. After successful completion of vehicle service, the successful results of the service operation may be transmitted back to the remote server to be additionally stored as part of the corpus. Thus, over time this corpus provides a more robust and comprehensive dataset for a machine-learning method to assist the diagnostic processor in making diagnostic assessments of vehicles of a particular make and model. In some embodiments, the information requiring authorization may stored locally on a memory in data communication with the diagnostic processor, and may instead be accessed via a password, fingerprint scan, voiceprint qualification, retinal scan, facial recognition scane, or any other security mechanism recognized by one of ordinary skill in the art without deviating from the teachings disclosed herein.

If access is not authorized at step 420, the method updates the HMI to inform the user of this at step 422. In the depicted embodiment, step 420 additionally comprises a sub-step of offering a user the opportunity to acquire authorization via a payment. This payment request may be for one or more of a subscription payment, an ad hoc payment, or an a la carte payment. If the user rejects this request, the method proceeds to step 422, updates the interface with the most up-to-date information about the diagnostics, and then ends. If the user has or acquires authorization, the method instead proceeds to step 424, where steps to perform one or more service actions are acquired from the remote server and presented via the HMI at step 426. The method than proceeds to guide a user through steps of a first service operation at step 428. One or more service operations may be presented to a user, and the diagnostic processor may pre-select which of the service operations is next for the user, or the user may select which is preferred without deviating from the teachings disclosed herein.

By way of example, and not limitation, the additional service instructions may be related to one or more additional service operations suitable to address potential conditions of the vehicle that may be causing suboptimal volumetric efficiency. The additional service operations may comprise a sensor verification, an exhaust pressure measurement, an air filter inspection, a cylinder compression check, or an audio analysis. In a sensor verification, one or more mass airflow sensors (such as mass airflow sensor 103; see FIG. 1) may be tested or calibrated to determine if the data generated is erroneous. In an exhaust pressure measurement, a pressure sensor within an exhaust conduit (such as exhaust conduit 217; see FIG. 2) and pressure readings are used to determine if a blockage or leak exists within the exhaust conduit. In an air filter inspection, an air filter (such as air filter 201; see FIG. 2) is visually inspected for a condition warranting a replacement with a new filter. In some embodiments, the visual inspection of the air filter may be accomplished by machine-learning diagnostic of the diagnostic processor, utilizing a camera associated with the diagnostic processor to generate image data depicting the air filter and it's current condition. The machine-learning diagnostic may utilize a corpus of image data stored locally or on the remote server for a comparison between the vehicle's air filter and air filters observed during pervious service operations. Other embodiments may comprise a visual inspection by a user, but may additionally present to the user illustrations of conditions of an air filter that do and do not require replacement for visual reference without deviating from the teachings disclosed herein. In a cylinder compression check, a spark plug may be removed from the engine to permit the insertion of a pressure sensor within one or more cylinders (such as cylinders 215) of the engine to determine if the integrity of the cylinders is satisfactory. In an audio analysis, the sound of the engine during operation may be audibly inspected to determine one or more other potential operating conditions of the engine. In some embodiments, audio analysis of the engine may be accomplished by a machine-learning diagnostic of the diagnostic processor, utilizing a microphone associated with the diagnostic processor to generate audio data depicting the sounds of the engine during operation. The machine-learning diagnostic may utilize a corpus of audio data stored locally or on the remote server for a comparison between the vehicle's audible operating sounds and the audible operating sounds of previous vehicles during previous service operations. Other embodiments a listening inspection performed by the user, but may additional present to the user recorded audio depicting engines of similar make and models as the vehicle under service that do and do not require additional service operations for audible comparison without deviating from the teachings disclosed herein.

After the service operation is completed, the method checks to see if the volumetric efficiency of the engine is within the expected range or ranges at step 430. If the volumetric efficiency is within the expected value range, the previous service operation is considered to have addressed the issue, and this information is transmitted back to the remote server to be included in the corpus of diagnostic history data. If the volumetric efficiency is not brought within the expected threshold values by the service operation, the method proceeds to step 434 to determine if any additional service operations may be performed from the list of service operations acquired in step 424. If any service steps remain, the method proceeds to step 430 where the system is updated with new volumetric efficiency data and the list of service operations is updated to remove the recently-completed service operation, before the method returns to step 426 to present the next service operation. This iterative process continues until either the volumetric efficiency is found to be within the specified threshold values at step 430 or no additional service steps remain at step 434. If no additional service steps remain, the user is informed of the status and the method ends. If some additional service steps are available that the user is not currently authorized to access, the user may be presented with the option to provide payment for additional access at step 434, and these additional service operations may be made available at step 430 during the next iteration of service operation. In this manner, a user utilizing an ad hoc payment structure can continue to only pay for needed service information on an as-needed basis. If the user declines, or the total list of service operations is otherwise exhausted, the method ends at step 440.

In some embodiments, a user may instead be provided with a list of service operations at steps 424, 426, and 428, but may not be provided with specific steps to complete the service operation. This advantageously permits a user that is an experienced technician to perform the service operations without interrupting the normal operation of the diagnostic processor during service to provide unneeded information. In such embodiments, the list of service operations may be viewed by a user having a lesser authorization status than the guided instructions for one or more additional service operations without deviating from the teachings disclosed herein.

Some embodiments may not comprise steps 420-424 without deviating from the teachings disclosed herein. Some embodiments may utilize fewer or additional update steps (e.g., steps 406, 410, 422, 430 and 432) without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A diagnostic method for an internal combustion engine, the method comprising:
establishing a data connection between a diagnostic processor and a vehicle communication bus (VCB) of a vehicle utilizing the engine;
requesting mass airflow data from the VCB, the mass airflow data indicating mass airflow of combined cylinders of the engine during operation of the engine;
displaying the mass airflow data on a display in data communication with the diagnostic processor in response to reception of the mass airflow data from the VCB;
generating an efficiency indicator of a volumetric efficiency of the engine based upon the mass airflow data;
generating a diagnosis indicator based upon the volumetric efficiency; and
displaying the efficiency indicator and the diagnosis indicator on the display,
wherein
the VCB acquires the mass airflow data from a sensor in data communication with the VCB,
the diagnosis indicator indicates normal operation of the engine in response to the volumetric efficiency being equal to or greater than a threshold value, and
the diagnosis indicator indicates an engine fault in response to the volumetric efficiency being below the threshold value.

2. The diagnostic method of claim 1, wherein the threshold value is established using identifying data associated with the vehicle.

3. The diagnostic method of claim 2, wherein the identifying data is acquired from the VCB.

4. The diagnostic method of claim 2, further comprising:
transmitting the mass airflow data, volumetric efficiency, and identifying data to a memory in data communication with the diagnostic processor, the memory storing thereon a corpus of diagnostic history data; and
appending the mass airflow data, volumetric efficiency, and identifying data to the corpus of diagnostic history data.

5. The diagnostic method of claim 4, wherein the data communication between the memory and the diagnostic processor utilizes a network connection.

6. The diagnostic method of claim 1, wherein the sensor is disposed within the engine airflow path between an air filter and an intake manifold of the engine.

7. The diagnostic method of claim 1, wherein the diagnosis indicator comprises additional service instructions in response to the volumetric efficiency being below the threshold value.

8. The diagnostic method of claim 7, wherein the additional service instructions comprise instructions to perform a sensor verification, an exhaust pressure measurement, an air filter inspection, a cylinder compression check, or an audio analysis.

9. The diagnostic method of claim 1, wherein the indicator of volumetric efficiency comprises a moving average value for the volumetric efficiency, the moving average value being determined using a series of mass airflow data measurements corresponding to a predetermined window of time during operation of the engine.

10. A diagnostic system comprising:
a mass airflow sensor disposed in the airflow pathway of an engine between an air filter and intake manifold of the engine, the mass airflow sensor generating mass airflow data indicating mass airflow conditions of the engine;
a diagnostic bus in data communication with the mass airflow sensor;
a diagnostic processor in data communication with the diagnostic bus, the diagnostic processor configured to transmit commands to the diagnostic bus and receive data from the diagnostic bus; and
a display in data communication with the diagnostic processor, the diagnostic processor configured to transmit diagnosis data for output via the display,
wherein
the diagnostic bus acquires the mass airflow data from the mass airflow sensor,
the diagnostic bus transmits the mass airflow data to the diagnostic processor,
the diagnostic processor generates a volumetric efficiency of the engine based upon the mass airflow data,
the diagnosis data indicates normal operation of the engine in response to the volumetric efficiency being equal to or greater than a threshold value, and
the diagnosis data indicates an engine fault in response to the volumetric efficiency being below the threshold value.

11. The diagnostic system of claim 10, further comprising a memory in data communication with the diagnostic processor, the memory having stored thereon an expected mass airflow value that is used to generate the threshold value.

12. The diagnostic system of claim 11, wherein the memory further stores thereon a plurality of expected mass airflow values, each of the plurality of mass airflow values corresponding to a particular model and operating condition of an engine under test,
wherein
the diagnostic bus transmits identifying data to the diagnostic processor, the identifying data associated with the model of the engine,
the diagnostic bus transmits tachometer data to the diagnostic processor, the tachometer data indicating a load of the engine, and
the diagnostic processor utilizes the identifying data and tachometer data in generating the volumetric efficiency data.

13. The diagnostic system of claim 10, wherein
the diagnostic processor is configured to generate additional service instructions in response to the volumetric efficiency being below the threshold value and transmits the additional service instructions to the display.

14. The diagnostic system of claim 13, wherein the additional service instructions comprise instructions to perform a sensor verification, an exhaust pressure measurement, an air filter inspection, a cylinder compression check, or an audio analysis.

15. The diagnostic system of claim 10, further comprising a memory in data communication with the diagnostic processor, the memory storing thereon a corpus of diagnostic history data, the diagnostic processor utilizing the corpus in generating additional service instructions.

16. The diagnostic system of claim 15, wherein the memory comprises a remote memory, and wherein the data communication between the remote memory and the diagnostic processor comprises a network connection.
